(19) United States
(12) Patent Application Publication
(10) Pub. No.: US 2026/0091586 A1
(43) Pub. Date: Apr. 2, 2026

(54) Liquid Ejecting Head And Liquid Ejecting Apparatus

(71) Applicant: SEIKO EPSON CORPORATION, Tokyo (JP)

(72) Inventors: Takahiro KATAKURA, Okaya (JP); Takanori AIMONO, Shiojiri (JP); Mitsuki EBISAWA, Shiojiri (JP)

(21) Appl. No.: 19/346,949

(22) Filed: Oct. 1, 2025

(30) Foreign Application Priority Data
Oct. 2, 2024 (JP) 2024-173062

(51) Int. Cl. B41J 2/14

(52) U.S. Cl. CPC B41J 2/14233; B41J 2/1433; B41J 2002/14306; B41J 2002/14419

(57) ABSTRACT

A liquid ejecting head includes a first individual flow path and a second individual flow path arranged side by side in a first direction, the first individual flow path includes a first pressure chamber applying pressure to liquid, a first communication flow path including a first portion extending in a third direction, and a first nozzle ejecting liquid, the second individual flow path includes a second pressure chamber applying pressure to liquid, a second communication flow path communicating with the second pressure chamber and including a second portion extending in the third direction, and a second nozzle ejecting liquid, and when viewed from the third direction, the first nozzle is located further on one side than the first portion in the second direction, and the second nozzle is located further on another side than the second portion in the second direction.

The present application is based on, and claims priority from JP Application Serial Number 2024-173062, filed Oct. 2, 2024, the disclosure of which is hereby incorporated by reference herein in its entirety.

### BACKGROUND

### 1. Technical Field

The present disclosure relates to a liquid ejecting head and a liquid ejecting apparatus which eject liquid from a nozzle, and particularly to an ink jet recording head and an ink jet recording apparatus which eject ink as liquid.

### 2. Related Art

An ink jet recording head which is a representative example of a liquid ejecting head which ejects liquid droplets includes, for example, a nozzle and a flow path such as a pressure chamber which communicates with the nozzle, and ink droplets are ejected from the nozzle by causing a pressure change in ink in the pressure chamber using a pressure generating unit.

In such a liquid ejecting head, nozzles and pressure chambers are arranged in a single row to perform high-resolution printing (for example, see JP-A-2022-013678).

In JP-A-2022-013678, the pressure chambers and the nozzles are coupled by communication flow paths. However, since a positional relationship between the nozzles and the communication flow paths is the same within the nozzle row and the nozzles are arranged in a single row, when ink is ejected at a high duty, air cannot pass between the liquid ejecting head and a medium due to a flow velocity of the flying ink droplets, and the air flows toward an end portion in the row direction, and a landing position of the ink droplets may be deviated. In particular, as a distance between the liquid ejecting head and the medium increases, a flow velocity barrier increases, and a flight time of the ink droplets becomes longer. As a result, the landing position deviation becomes more pronounced.

When a distance between adjacent nozzles is short and the nozzles are arranged at a high density, satellite droplets separated from main droplets are greatly swirled up by an airflow due to ejected ink droplets and irregularly adhere to a medium, and thus printing contamination called wind ripple occurs.

By arranging the pressure chambers at a low density, it is possible to suppress the landing position deviation due to the flow velocity and the wind ripple, but there is a problem in that the liquid ejecting head is increased in size.

### SUMMARY

According to an aspect of the present disclosure for solving the above-described problem, a liquid ejecting head includes a first individual flow path and a second individual flow path arranged side by side with the first individual flow path in a first direction, in which the first individual flow path includes a first pressure chamber extending along a second direction intersecting the first direction and configured to apply pressure to liquid, a first communication flow path that communicates with the first pressure chamber and includes a first portion extending in a third direction intersecting the first direction and the second direction, and a first nozzle that communicates with the first communication flow path and ejects liquid, the second individual flow path includes a second pressure chamber extending along the second direction and configured to apply pressure to liquid, a second communication flow path that communicates with the second pressure chamber and includes a second portion extending in the third direction, and a second nozzle that communicates with the second communication flow path and ejects liquid, and when viewed from the third direction, the first nozzle is located further on one side than the first portion in the second direction, and the second nozzle is located further on another side than the second portion in the second direction.

According to another aspect of the present disclosure, a liquid ejecting apparatus includes the liquid ejecting head according to the above aspect, and a control portion configured to control an ejecting operation from the liquid ejecting head.

### BRIEF DESCRIPTION OF THE DRAWINGS

FIG. 1 is an exploded perspective view of a liquid ejecting head according to a first embodiment.

FIG. 2 is a plan view of the liquid ejecting head according to the first embodiment.

FIG. 3 is a sectional view of the liquid ejecting head according to the first embodiment.

FIG. 4 is an enlarged sectional view of a main portion of the liquid ejecting head according to the first embodiment.

FIG. 5 is a sectional view of the liquid ejecting head according to the first embodiment.

FIG. 6 is an enlarged sectional view of a main portion of the liquid ejecting head according to the first embodiment.

FIG. 7 is a plan view showing a positional relationship of individual flow paths according to the first embodiment.

FIG. 8 is a plan view showing a positional relationship of individual flow paths according to a comparative example.

FIG. 9 is a plan view showing a positional relationship of individual flow paths according to a second embodiment.

FIG. 10 is a plan view showing a positional relationship of individual flow paths according to a modification example of the second embodiment.

FIG. 11 is a plan view showing a positional relationship of individual flow paths according to a modification example of the second embodiment.

FIG. 12 is a plan view showing a positional relationship of individual flow paths according to a third embodiment.

FIG. 13 is a diagram showing a schematic configuration of a liquid ejecting apparatus according to an embodiment.

### DESCRIPTION OF EMBODIMENTS

The present disclosure will be described in detail below based on embodiments. However, the following description merely shows one embodiment of the present disclosure, and can be modified as desired within the scope of the present disclosure. In each drawing, the same reference numerals indicate the same members, and the description thereof will be omitted as appropriate. In each drawing, X, Y, and Z represent three spatial axes that are orthogonal to each other. In the present specification, directions along these axes are referred to as an X direction, a Y direction, and a Z direction. In each drawing, a direction indicated by the arrow is a positive (+) direction, and a direction opposite to the arrow is a negative (−) direction. The Z direction indicates a vertical direction, the +Z direction indicates a vertically downward direction, and the −Z direction indicates a vertically upward direction. Furthermore, the directions of the three spatial axes, which are not limited to the positive direction and the negative direction, will be described as an X-axis direction, a Y-axis direction, and a Z-axis direction.

### First Embodiment

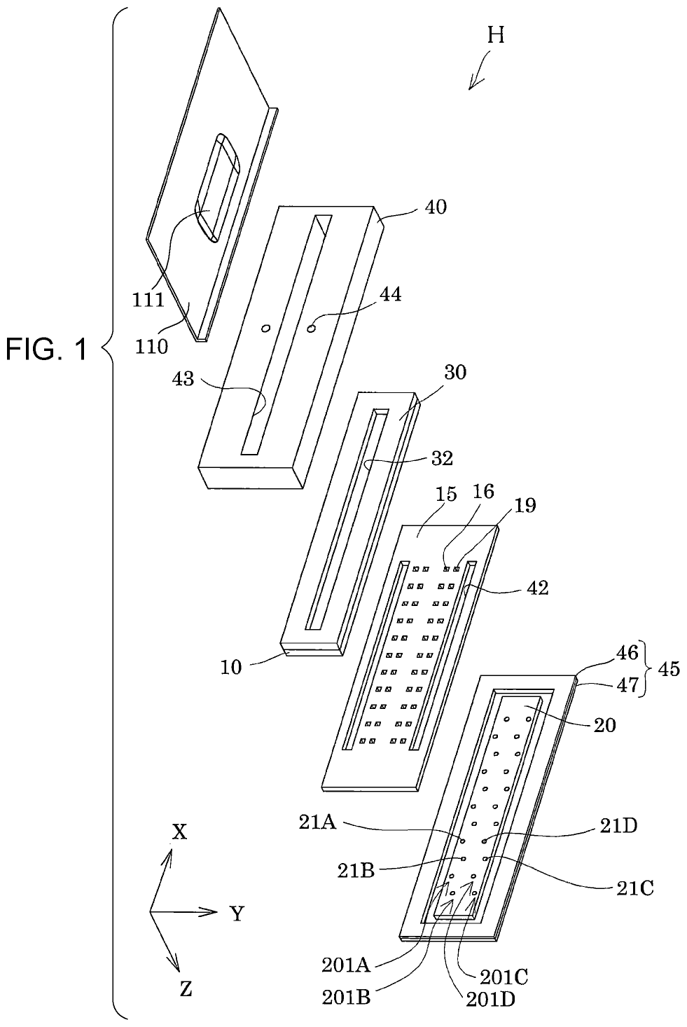

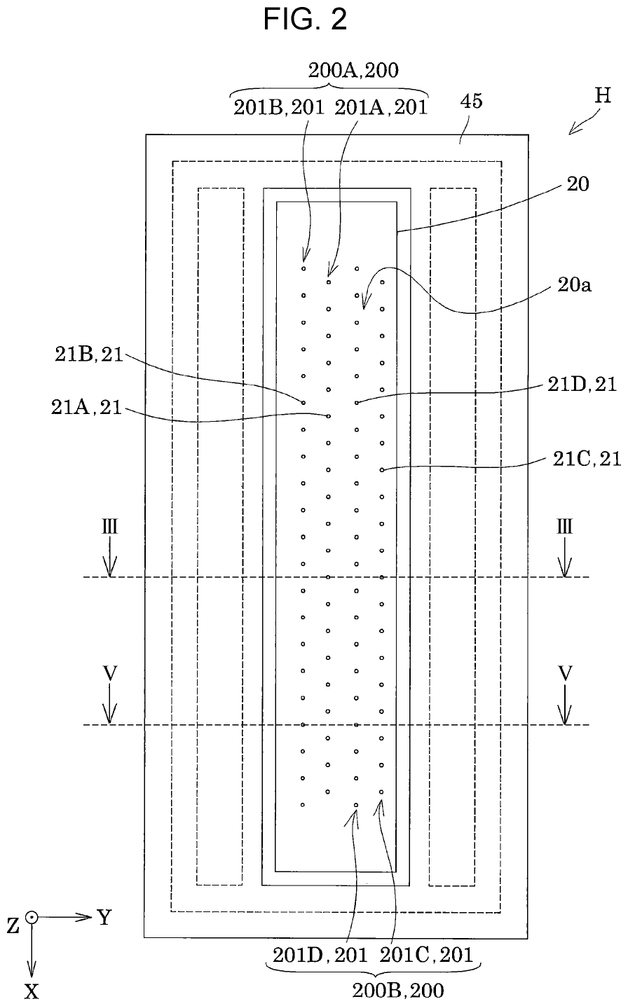

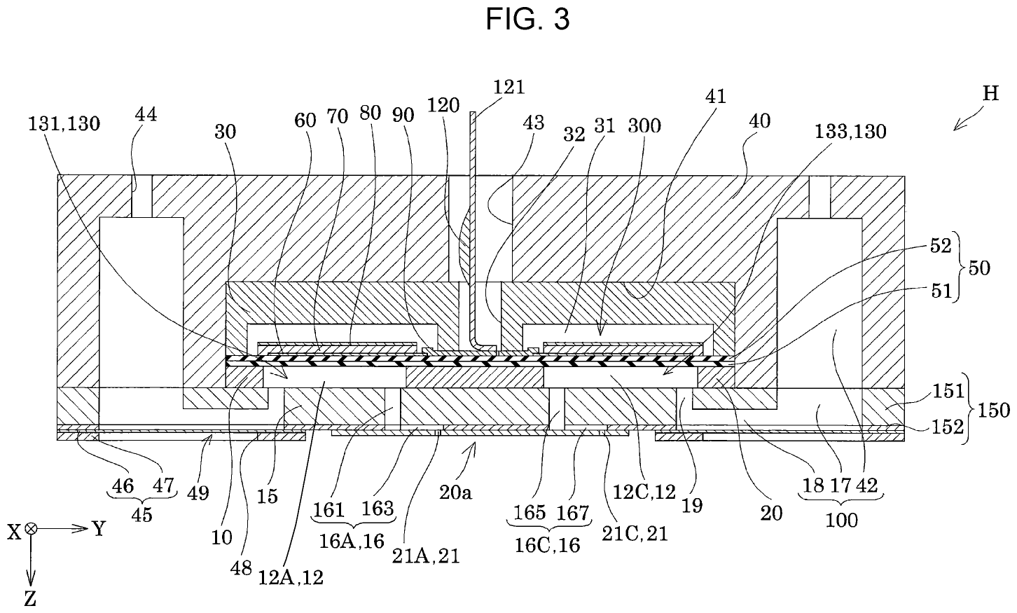

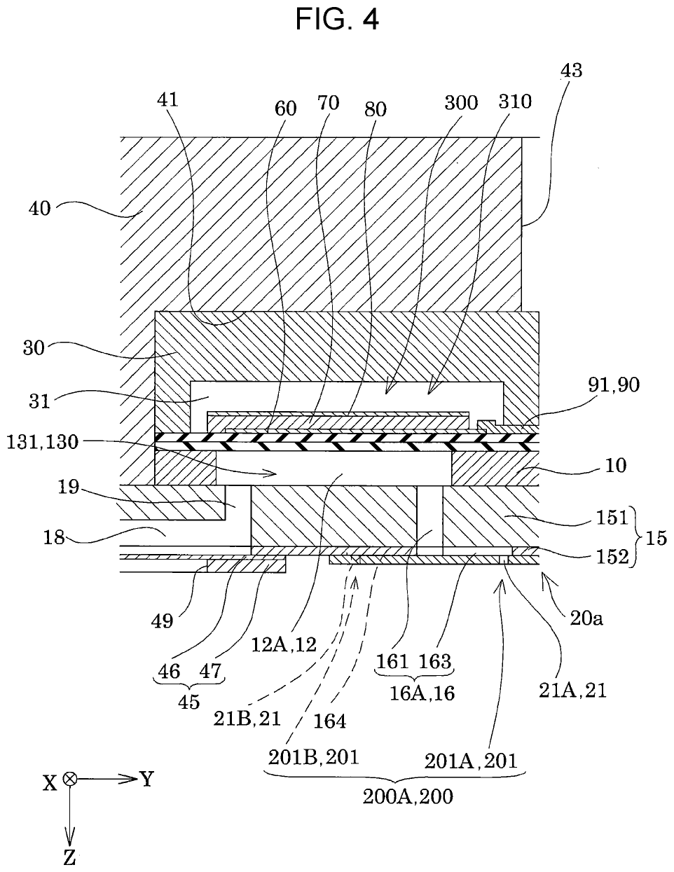

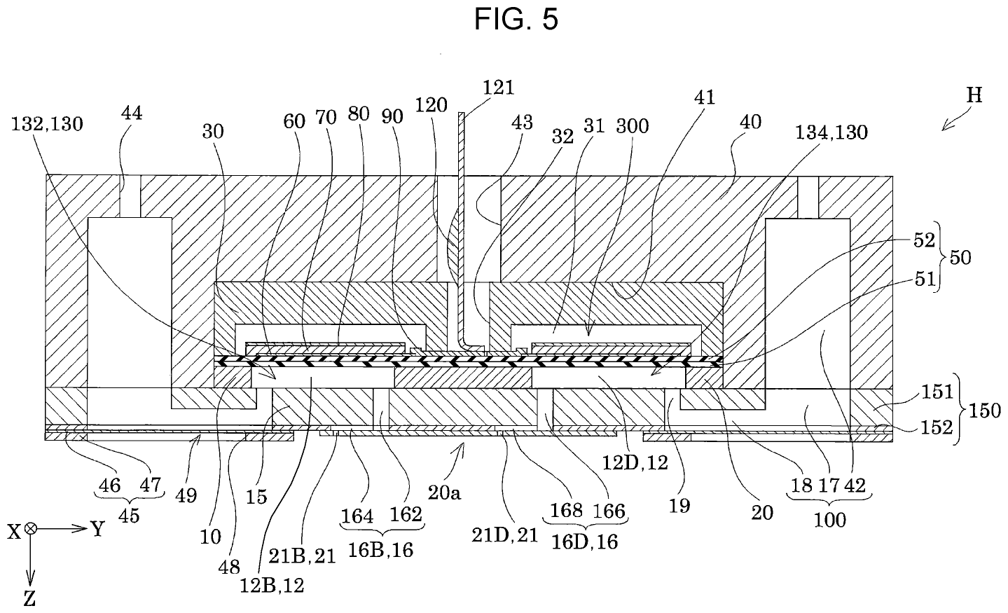

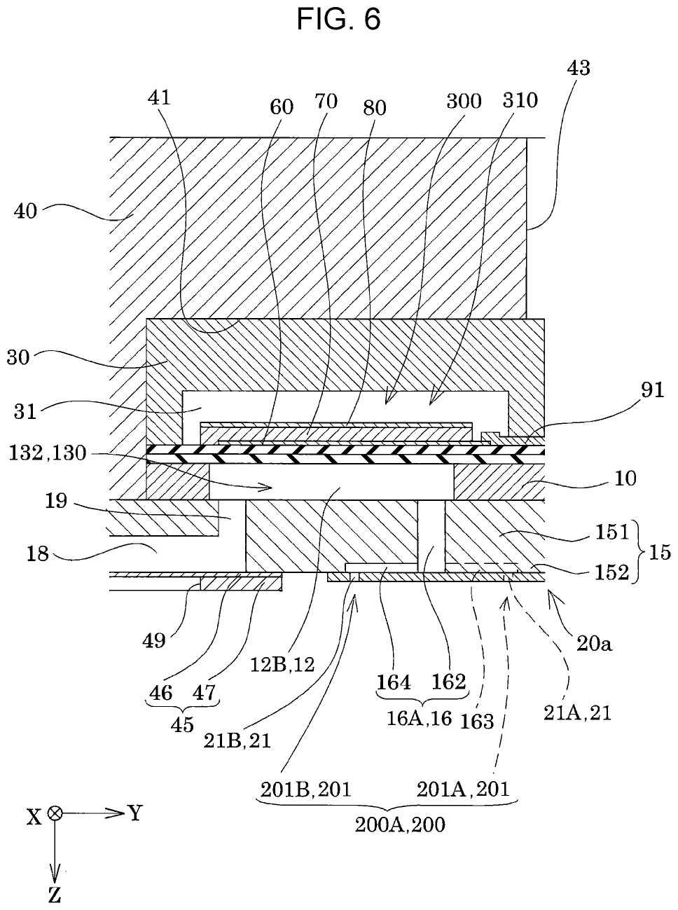

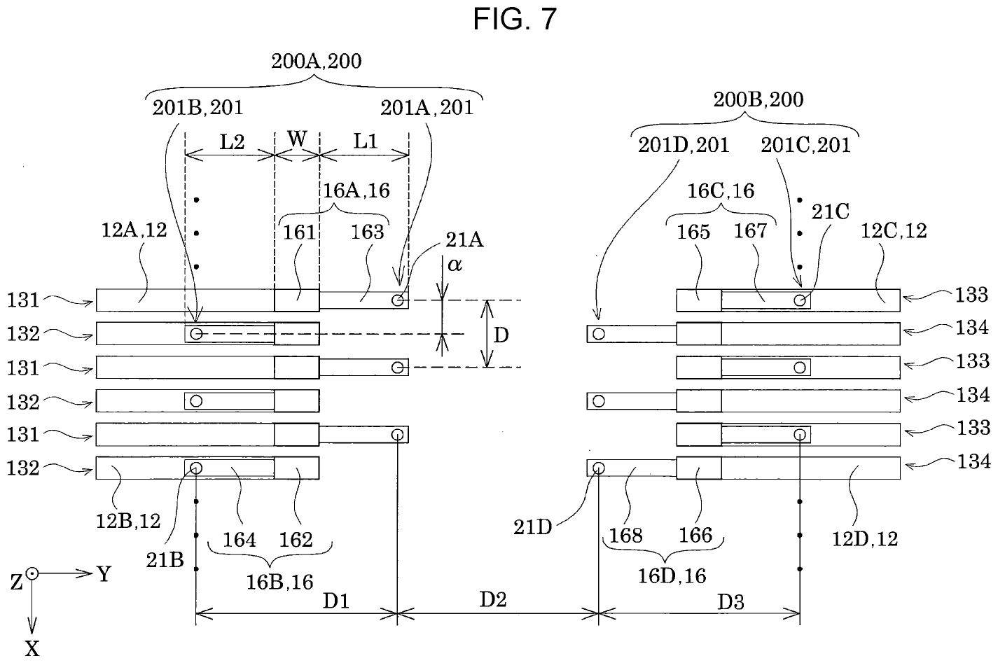

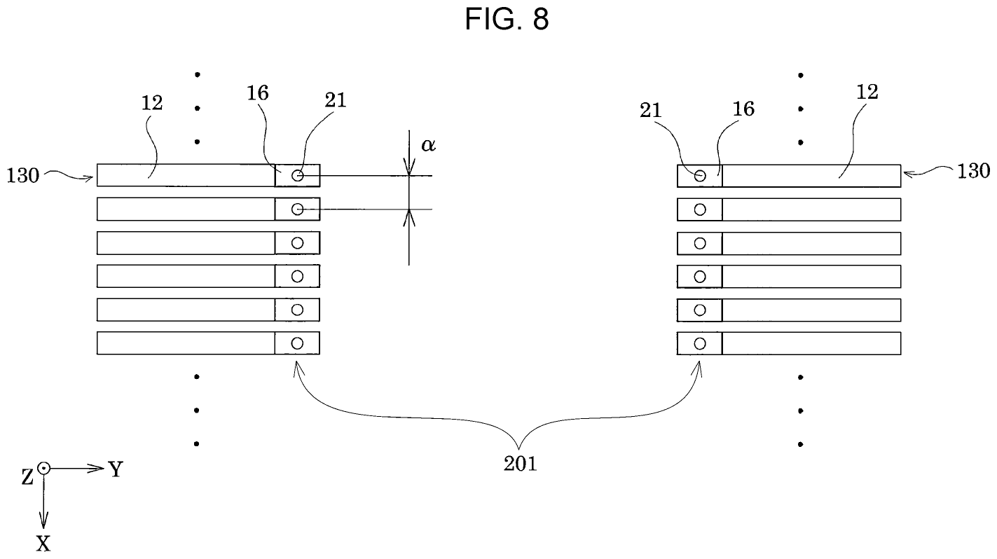

FIG. 1 is an exploded perspective view of a liquid ejecting head H according to a first embodiment of the present disclosure. FIG. 2 is a plan view of the liquid ejecting head H according to the first embodiment as viewed in the −Z direction. FIG. 3 is a sectional view taken along line III-III in FIG. 2. FIG. 4 is an enlarged view of a main portion of FIG. 3. FIG. 5 is a sectional view taken along line V-V in FIG. 2. FIG. 6 is an enlarged view of a main portion of FIG. 5. FIG. 7 is a view of the liquid ejecting head H showing a positional relationship of individual flow paths according to the first embodiment, as viewed in the −Z direction. FIG. 8 is a plan view of the liquid ejecting head H showing a positional relationship of individual flow paths according to a comparative example, as viewed in the −z direction.

As shown in the drawings, the liquid ejecting head H of the embodiment includes a pressure chamber substrate 10, a communication plate 15, a nozzle plate 20 in which a plurality of nozzles 21 are formed, a protective substrate 30, a case member 40, a piezoelectric actuator 300, and a wiring substrate 120.

The pressure chamber substrate 10 is formed of, for example, a silicon substrate, a glass substrate, an SOI substrate, or various ceramic substrates. In the pressure chamber substrate 10, a plurality of pressure chambers 12 are arranged side by side along the X-axis direction. Each of the pressure chambers 12 extends along the Y-axis direction. That is, the pressure chamber 12 has a so-called high aspect ratio and is long in the Y-axis direction and short in the X-axis direction. The direction in which the pressure chamber 12 extends is a longitudinal direction of the pressure chamber 12 and coincides with the Y-axis direction. The plurality of pressure chambers 12 are arranged on a straight line in the X-axis direction to be at the same position in the Y-axis direction. That is, the plurality of pressure chambers 12 have substantially the same length in the Y-axis direction and are arranged at the same position in the Y-axis direction, that is, such that both end portions in the Y-axis direction are located at the same position in the Y-axis direction. Two pressure chambers 12 adjacent to each other in the X-axis direction are partitioned by a partition wall. In the present embodiment, two pressure chamber rows, in which the pressure chambers 12 are arranged side by side along the X-axis direction, are provided in the Y-axis direction. Only one pressure chamber row may be provided, or three or more pressure chamber rows may be provided. The arrangement of the pressure chambers 12 is not particularly limited thereto, and for example, the plurality of pressure chambers 12 may be arranged in a staggered manner along the X-axis direction. Here, the pressure chambers 12 being arranged in a staggered manner along the X-axis direction means that the pressure chambers 12 arranged side by side in the X-axis direction are alternately arranged to be shifted in the Y-axis direction. That is, two pressure chamber rows, each including the pressure chambers 12 arranged side by side in the X-axis direction, are provided in the Y-axis direction, and the two pressure chamber rows are arranged to be shifted from each other in the X-axis direction by half the pitch of, that is, a so-called half pitch of the pressure chambers 12. In the present embodiment, the pressure chamber 12 has a high aspect ratio and is long in the Y-axis direction and short in the X-axis direction, but the present disclosure is not particularly limited thereto. For example, the pressure chamber 12 may have substantially the same length in the X-axis direction and the Y-axis direction. The direction in which the pressure chamber 12 extends may be a direction in which ink flows. As will be described in detail later, since at both end portions of the pressure chamber 12 in the Y-axis direction, a supply communication path 19 which allows ink to flow into the pressure chamber 12 and a communication flow path 16 which allows ink in the pressure chamber 12 to flow out are coupled, respectively, the direction in which ink flows in the pressure chamber 12 coincides with the Y-axis direction.

The communication plate 15 and the nozzle plate 20 are sequentially stacked in the +Z direction on a surface of the pressure chamber substrate 10 facing in the +Z direction. A diaphragm 50 and the piezoelectric actuator 300 are sequentially stacked in the −Z direction on a surface of the pressure chamber substrate 10 facing in the −Z direction.

The communication plate 15 is made of a plate-shaped member bonded to the surface of the pressure chamber substrate 10 facing in the +Z direction. The communication plate 15 is provided with the communication flow path 16 through which the pressure chamber 12 and the nozzle 21 communicate with each other. The communication plate 15 is provided with a first manifold portion 17 and a second manifold portion 18 which constitute a portion of a manifold 100 serving as a common liquid chamber (also referred to as a common supply flow path) in which the plurality of pressure chambers 12 communicate in common for each row of the pressure chambers 12. The first manifold portion 17 is provided to penetrate the communication plate 15 in the Z-axis direction. The second manifold portion 18 is provided so as to be open on the surface facing in the +Z direction without penetrating the communication plate 15 in the Z-axis direction. Furthermore, the communication plate 15 is independently provided with the supply communication path 19 that communicates with one end portion of the pressure chamber 12 in the Y-axis direction for each pressure chamber 12. The supply communication path 19 communicates between the second manifold portion 18 and the pressure chamber 12 to supply the ink in the manifold 100 to the pressure chamber 12. As the communication plate 15, a silicon substrate or an SOI substrate is preferably used. The material of the communication plate 15 is not limited thereto, and a glass substrate, various ceramic substrates, a metal substrate such as a stainless steel substrate, or the like may be used.

On the other hand, as shown in FIG. 3, the diaphragm 50 is provided on the surface of the pressure chamber substrate 10 facing in the −Z direction. The diaphragm 50 has, for example, an elastic film 51 made of silicon oxide provided on the pressure chamber substrate 10 side, and an insulator film 52 made of zirconium oxide provided on a surface of the elastic film 51 facing in the −Z direction. The diaphragm 50 may be formed of only the elastic film 51 or only the insulator film 52. The diaphragm 50 may include another film in addition to the elastic film 51 and the insulator film 52. The material of the diaphragm 50 is not limited to those described above.

The piezoelectric actuator 300 includes a first electrode 60, a piezoelectric layer 70, and a second electrode 80 that are sequentially stacked on the diaphragm 50 in the −Z direction. Such a piezoelectric actuator 300 is also called a piezoelectric element, and refers to a portion including the first electrode 60, the piezoelectric layer 70, and the second electrode 80. A portion where piezoelectric strain occurs in the piezoelectric layer 70 when a voltage is applied between the first electrode 60 and the second electrode 80 is referred to as an active portion 310. In other words, the active portion 310 refers to a portion where the piezoelectric layer 70 is interposed between the first electrode 60 and the second electrode 80. In the present embodiment, the active portion 310 is formed for each pressure chamber 12. That is, in the piezoelectric actuator 300, a plurality of active portions 310 are arranged side by side in the X-axis direction. The active portions 310 serve as drive elements that cause pressure changes in the ink in the pressure chamber 12. In general, one of the electrodes for the active portion 310 is configured as an individual electrode independent of each of the active portions 310, and the other electrode is configured as a common electrode shared by the plurality of active portions 310. In the present embodiment, the first electrode 60 is configured as an individual electrode, and the second electrode 80 is configured as a common electrode. The first electrode 60 may form a common electrode, and the second electrode 80 may form an individual electrode.

The piezoelectric layer 70 is formed, for example, using a piezoelectric material made of a composite oxide having a perovskite structure represented by the general formula ABO₃.

An individual lead electrode 91 serving as a lead-out wiring is pulled out from the first electrode 60. A common lead electrode (not shown) is pulled out from the second electrode 80. A wiring substrate 120 having flexibility is coupled to end portions of these individual lead electrode 91 and common lead electrode opposite to end portions coupled to the piezoelectric actuator 300. The wiring substrate 120 is mounted with a drive circuit 121 having a plurality of switching elements for selecting whether or not to supply a drive signal for driving each of the active portions 310 to each of the active portions 310. That is, the wiring substrate 120 in the present embodiment is a Chip on Film (COF). The wiring substrate 120 need not be provided with the drive circuit 121. That is, the wiring substrate 120 may be a Flexible Flat Cable (FFC), a Flexible Printed Circuit (FPC), and the like.

The protective substrate 30 having substantially the same size as the pressure chamber substrate 10 is bonded to the surface of the pressure chamber substrate 10 facing in the −Z direction. The protective substrate 30 has a piezoelectric actuator accommodation portion 31 which is a space for protecting the piezoelectric actuator 300. The piezoelectric actuator accommodation portion 31 is independently provided for each row of the piezoelectric actuators 300 arranged side by side in the X-axis direction, and two piezoelectric actuator accommodation portions 31 are formed side by side in the Y-axis direction. A through-hole 32 penetrating in the Z-axis direction is provided between two piezoelectric actuator accommodation portions 31 arranged side by side in the Y-axis direction, in the protective substrate 30. The end portions of the individual lead electrode 91 and a common lead electrode (not shown) pulled out from electrodes of the piezoelectric actuator 300 extend to be exposed within the through-hole 32, and the individual lead electrode 91 and the common lead electrode are electrically coupled to the wiring substrate 120 within the through-hole 32. Such a protective substrate 30 is made of a silicon substrate, similar to the pressure chamber substrate 10, for example.

The case member 40 that defines a portion of the manifold 100 that communicates with the plurality of pressure chambers 12 is fixed onto the protective substrate 30. The case member 40 has substantially the same shape as the communication plate 15 described above in a plan view, and is bonded not only to the protective substrate 30, but also to the communication plate 15 described above. Such a case member 40 has a recessed portion 41 having a depth for accommodating the pressure chamber substrate 10 and the protective substrate 30 on the protective substrate 30 side. The case member 40 is also provided with a third manifold portion 42 that communicates with the first manifold portion 17 of the communication plate 15. The first manifold portion 17 and the second manifold portion 18 provided in the communication plate 15 and the third manifold portion 42 provided in the case member 40 constitute the manifold 100 of the present embodiment. The manifold 100 is continuously provided in the X-axis direction, which is the arrangement direction of the pressure chambers 12, and is provided for each row of the pressure chambers 12, that is, two in total. The case member 40 also has an introduction port 44 that communicates with the manifolds 100 and supplies ink to each manifold 100.

The case member 40 has a wiring connection port 43 which communicates with the through-hole 32 of the protective substrate 30 and into which the wiring substrate 120 is inserted, and the wiring substrate 120 is led to a surface side of the liquid ejecting head H which faces in the −Z direction via the wiring connection port 43. The case member 40 is made of, for example, a metal material or a resin material.

A compliance substrate 45 is provided on a surface facing in the +Z direction in which the first manifold portion 17 and the second manifold portion 18 of the communication plate 15 are opened. The compliance substrate 45 seals openings of the first manifold portion 17 and the second manifold portion 18. In the present embodiment, such a compliance substrate 45 includes a sealing film 46 made of a flexible thin film, and a fixed substrate 47 made of a hard material such as metal. Since a region of the fixed substrate 47 facing the manifold 100 is an opening portion 48 that is completely removed in a thickness direction, one surface of the manifold 100 is a compliance portion 49 which is a flexible portion sealed only by the flexible sealing film 46.

The nozzle plate 20 is bonded to a surface of the communication plate 15 facing in the +Z direction. The nozzle plate 20 is made of a plate-shaped member, and a silicon substrate or an SOI substrate is preferably used. The material of the nozzle plate 20 is not limited to this, and a glass substrate, various ceramic substrates, a metal substrate such as a stainless steel substrate, an organic material such as a polyimide resin, or the like may be used.

In the nozzle plate 20, a plurality of nozzles 21 which communicate with the respective pressure chambers 12 via the communication flow path 16 are formed. In the present embodiment, one nozzle 21 is arranged for one pressure chamber 12. That is, the liquid ejecting head H of the present embodiment includes one supply communication path 19, one pressure chamber 12, one communication flow path 16, and one nozzle 21 as the individual flow path 130. The individual flow path may include two supply communication paths 19 and may include two nozzles 21.

In the present embodiment, since two pressure chamber rows, each including the pressure chambers 12 arranged side by side in the X-axis direction, are provided, two nozzle row groups 200, each including nozzles 21 arranged side by side in the X-axis direction, are arranged side by side in the Y-axis direction. Of the two nozzle row groups 200, the nozzle row group 200 located in the −Y direction is referred to as a nozzle row group 200A, and the nozzle row group 200 located in the +Y direction is referred to as a nozzle row group 200B. Hereinafter, when the nozzle row groups 200A and 200B are not distinguished from each other, they are referred to as a nozzle row group 200. The same type of ink is ejected from the nozzles 21 constituting each of the nozzle row groups 200A and 200B. A surface facing in the +Z direction in which the nozzles 21 of the nozzle plate 20 are opened is referred to as a nozzle surface 20a.

Here, the plurality of nozzles 21 constituting each nozzle row group 200 are arranged in a staggered manner along the X-axis direction. That is, in the nozzle row group 200, the adjacent nozzles 21 closest to each other in the X-axis direction are alternately arranged to be shifted in the Y-axis direction. Specifically, the nozzle row group 200 is configured such that two nozzle rows 201, which are rows of the nozzles 21 arranged side by side in the X-axis direction and are at the same position in the Y-axis direction, are arranged side by side in the Y-axis direction. The two nozzle rows 201 constituting one nozzle row group 200 are arranged to be shifted from each other by a half pitch of the nozzles 21 in the X-axis direction. Thus, the nozzles 21 of the nozzle row group 200 are arranged in a staggered manner along the X-axis direction. In the present embodiment, the nozzles 21 constituting the nozzle row located in the +Y direction of the nozzle row group 200A are referred to as first nozzles 21A, and the nozzles 21 constituting the nozzle row located in the −Y direction are referred to as second nozzles 21B. The nozzles 21 constituting the nozzle row located in the +Y direction of the nozzle row group 200B are referred to as third nozzles 21C, and the nozzles 21 constituting the nozzle row located in the −Y direction are referred to as fourth nozzles 21D. In the present embodiment, the nozzle row 201 configured by the first nozzles 21A is referred to as a nozzle row 201A, the nozzle row 201 configured by the second nozzles 21B is referred to as a nozzle row 201B, the nozzle row 201 configured by the third nozzles 21C is referred to as a nozzle row 201C, and the nozzle row 201 configured by the fourth nozzles 21D is referred to as a nozzle row 201D. The nozzle rows 201B, 201A, 201D, and 201C are arranged side by side in this order along the +Y direction. That is, the second nozzles 21B, the first nozzles 21A, the fourth nozzles 21D, and the third nozzles 21C are arranged side by side in this order along the +Y direction. In the present embodiment, the nozzles 21 of the nozzle row group 200A and the nozzles 21 of the nozzle row group 200B communicate with different manifolds 100. That is, the nozzles 21 of the nozzle row group 200A and the nozzles 21 of the nozzle row group 200B can eject different inks or the same ink.

Here, among the individual flow paths 130, the individual flow path 130 constituting the nozzle row group 200A, that is, the individual flow path 130 having the first nozzle 21A and the second nozzle 21B will be described.

As shown in FIGS. 4 and 7, the communication flow path 16 and the pressure chamber 12 which communicate with the first nozzle 21A are referred to as a first communication flow path 16A and a first pressure chamber 12A, and an individual flow path including the first pressure chamber 12A, the first communication flow path 16A, and the first nozzle 21A is referred to as a first individual flow path 131.

As shown in FIGS. 6 and 7, the communication flow path 16 and the pressure chamber 12 which communicate with the second nozzle 21B are referred to as a second communication flow path 16B and a second pressure chamber 12B, and an individual flow path including the second pressure chamber 12B, the second communication flow path 16B, and the second nozzle 21B is referred to as a second individual flow path 132. The first individual flow path 131 and the second individual flow path 132 communicate with one common manifold 100. Hereinafter, when the first individual flow path 131 and the second individual flow path 132 are not distinguished from each other, they are referred to as an individual flow path 130.

In the present embodiment, the first individual flow path 131 and the second individual flow path 132 are alternately arranged along the X-axis direction. That is, the second individual flow path 132 is arranged between the two first individual flow paths 131 arranged in the X-axis direction. The first individual flow path 131 is arranged between the two second individual flow paths 132 arranged in the X-axis direction.

Here, the first communication flow path 16A of the first individual flow path 131 has a first portion 161 extending in the Z-axis direction. The first nozzle 21A is located further on one side than the first portion 161 in the Y-axis direction, that is, further in the +Y direction than is the first portion 161 in the present embodiment. The first nozzle 21A being located further in the +Y direction than is the first portion 161 means that the first nozzle 21A and the first portion 161 do not overlap each other when viewed in the Z-axis direction, and the center of the first nozzle 21A is located further in the +Y direction than is the center of the first portion 161. The first communication flow path 16A further includes a third portion 163 having one end communicating with the first portion 161 and the other end communicating with the first nozzle 21A.

The first portion 161 is provided to penetrate the communication plate 15 in the Z-axis direction through an etching process or the like. The first portion 161 is provided linearly along the Z-axis direction with the same opening area. The one end of the first portion 161 communicates with an end portion of the first pressure chamber 12A in the +Y direction.

The third portion 163 extends in the +Y direction from the first portion 161 to the first nozzle 21A. The third portion 163 is defined by providing a recessed portion which is opened on a surface of the communication plate 15 facing in the +Z direction through an etching process or the like and covering the recessed portion with the nozzle plate 20. Specifically, the communication plate 15 of the present embodiment includes a first communication plate 151 and a second communication plate 152. The first communication plate 151 and the second communication plate 152 are stacked in this order toward the +Z direction. The third portion 163 is provided to penetrate the second communication plate 152 in the Z-axis direction. That is, the third portion 163 is defined by a recessed portion formed by a surface of the first communication plate 151 facing in the +Z direction and a groove provided in the second communication plate 152, the recessed portion being covered with the nozzle plate 20. The communication plate 15 may be formed of one substrate, or may be formed by stacking three or more substrates. By configuring the communication plate 15 with two or more stacked substrates as in the present embodiment, it is possible to easily form the depth of the third portion 163 in the Z-axis direction with high accuracy.

The third portion 163 has a so-called high aspect ratio and is long in the Y-axis direction and short in the X-axis direction. A direction in which the third portion 163 extends is a longitudinal direction based on a portion communicating with the first portion 161, and coincides with the +Y direction. In the present embodiment, the third portion 163 has a high aspect ratio and is long in the Y-axis direction and short in the X-axis direction, but the present disclosure is not particularly limited thereto. For example, the third portion 163 may have substantially the same length in the X-axis direction and the Y-axis direction, or may be longer in the X-axis direction and shorter in the Y-axis direction. In this case, the direction in which the third portion 163 extends is the direction in which the ink flows. That is, the direction in which the ink flows in the third portion 163 coincides with the +Y direction.

The second communication flow path 16B of the second individual flow path 132 has a second portion 162 extending in the Z-axis direction. The second nozzle 21B is located further on the other side than the second portion 162 in the Y-axis direction, that is, further in the −Y direction than is the second portion 162 in the present embodiment. The second nozzle 21B being located further in the −Y direction than is the second portion 162 means that the second nozzle 21B and the second portion 162 do not overlap each other when viewed in the Z-axis direction, and the center of the second nozzle 21B is located further in the −Y direction than is the center of the second portion 162. The second communication flow path 16B further includes a fourth portion 164 having one end communicating with the second portion 162 and the other end communicating with the second nozzle 21B.

The second portion 162 is provided to penetrate the communication plate 15 in the Z-axis direction through an etching process or the like. The second portion 162 is provided linearly along the Z-axis direction with the same opening area. The one end of the second portion 162 communicates with an end portion of the second pressure chamber 12B in the +Y direction.

The fourth portion 164 extends in the −Y direction from the second portion 162 to the second nozzle 21B. The fourth portion 164 is defined by providing a recessed portion which is opened on a surface of the communication plate 15 facing in the +Z direction through an etching process or the like and covering the recessed portion with the nozzle plate 20. In the present embodiment, the fourth portion 164 is provided to penetrate the second communication plate 152 in the Z-axis direction. That is, the fourth portion 164 is defined by a recessed portion formed by a surface of the first communication plate 151 facing in the +Z direction and a groove provided in the second communication plate 152, the recessed portion being covered with the nozzle plate 20. That is, the third portion 163 and the fourth portion 164 have the same depth in the Z-axis direction.

Similarly to the third portion 163, the fourth portion 164 has a so-called high aspect ratio and is long in the Y-axis direction and short in the X-axis direction. A direction in which the fourth portion 164 extends is a longitudinal direction based on a portion communicating with the second portion 162, and coincides with the −Y direction. Similarly to the third portion 163, the fourth portion 164 may have substantially the same length in the X-axis direction and the Y-axis direction, or may be longer in the X-axis direction and shorter in the Y-axis direction. In this case, the direction in which the fourth portion 164 extends is the direction in which the ink flows. That is, the direction in which the ink flows in the fourth portion 164 coincides with the −Y direction.

By arranging the first nozzles 21A and the second nozzles 21B in this manner, when the pressure chambers 12 are arranged at an interval of α[dpi] in the X-axis direction, the nozzles 21 in each nozzle row 201 can be arranged at a density of ½ of α[dpi], that is, α×½[dpi]. That is, in the nozzle row 201A, the first nozzles 21A can be arranged at a density of α×½[dpi] in the X-axis direction, and in the nozzle row 201B, the second nozzles 21B can be arranged at a density of α×½[dpi] in the X-axis direction. In the nozzle row group 200A, the nozzles 21 can be arranged at a high density of α[dpi] which is the same as that of the pressure chambers 12 in the X-axis direction by combining the first nozzle 21A and the second nozzle 21B.

In this manner, in each nozzle row 201, the nozzles 21 can be arranged at a density lower than that of the pressure chambers 12 in the X-axis direction. That is, in the nozzle row 201A, the first nozzles 21A can be arranged at a wider interval in the X-axis direction than the pressure chambers 12. Similarly, in the nozzle row 201B, the second nozzles 21B can be arranged at a wider interval in the X-axis direction than the pressure chambers 12. Therefore, since a gap is formed between the self-jets generated by ink ejected from each nozzle 21, an airflow between the medium and the liquid ejecting head can pass through the gap due to the relative movement between the medium and the liquid ejecting head H. Since the first nozzle 21A and the second nozzle 21B are sufficiently separated from each other in the Y-axis direction, a gap is also formed between the first nozzle 21A and the second nozzle 21B, and an airflow between the medium and the liquid ejecting head can pass through the gap due to the relative movement between the medium and the liquid ejecting head H. Therefore, since the airflow in a nozzle arrangement direction is suppressed, it is possible to suppress landing deviation due to the airflow of the flying ink and to cause the ink to land on a desired position of the medium.

By arranging the nozzles 21 constituting the nozzle row group 200A at a relatively wide interval in the X-axis direction, satellite droplets separated from the main droplets are less likely to be largely swirled up by the airflow of the ejected ink, and it is possible to suppress the occurrence of printing stains, called wind ripples, which are caused by irregular adhesion of the satellite droplets due to the airflow. Incidentally, when the nozzles 21 are close to each other and are arranged at a high density, the satellite droplets separated from the main droplets are largely swirled up by the airflow due to the ejected ink droplets and irregularly adhere to the medium, thereby generating the wind ripple.

In the present embodiment, in order to separate the first nozzle 21A and the second nozzle 21B in the Y-axis direction, it is sufficient to make both the first portion 161 and the second portion 162 penetrate in the Z-axis direction and make the third portion 163 and the fourth portion 164 extend in mutually opposite directions along the Y-axis direction, and for example, it is not necessary to provide a flow path portion that is inclined in both the Y-axis direction and the Z-axis direction. Therefore, the manufacturing process such as an etching process can be greatly simplified.

For example, as shown in FIG. 8, when the first nozzle 21A and the second nozzle 21B are arranged at the same position in the Y-axis direction without providing the third portion 163 and the fourth portion 164 in each of the first individual flow path 131 and the second individual flow path 132, by arranging the pressure chambers 12 arranged in the X-axis direction at a low density, that is, by widening the interval between the pressure chambers 12 arranged in the X-axis direction, the landing position deviation can be suppressed by widening the interval between the nozzles 21 as in the present embodiment. However, when the interval between the pressure chambers 12 is widened, the liquid ejecting head H is increased in size in the X-axis direction. Since the nozzles 21 are arranged at a low density in the X-axis direction, it is necessary to increase the number of times of reciprocating the liquid ejecting head with respect to the medium in order to perform high-resolution printing, and thus it takes time to perform printing. In the present embodiment, since the pressure chambers 12 can be arranged at a high density in the X-axis direction, it is possible to suppress an increase in the size of the pressure chamber substrate 10 in the X-axis direction, to arrange the nozzles 21 of each nozzle row 201 at a low density in the X-axis direction, and to suppress the landing position deviation of the ink. Moreover, in the nozzle row group 200A, since the first nozzles 21A and the second nozzles 21B are arranged at the same high density as the pressure chambers 12 in the X-axis direction, it is possible to suppress the decrease in printing resolution and shorten the printing time.

As shown in FIG. 7, when a distance between the first nozzle 21A and the first portion 161 in the Y-axis direction is L1 and a distance between the second nozzle 21B and the second portion 162 in the Y-axis direction is L2, 0.50×L1≤L2<2.00×L1 is preferably satisfied, 0.80×L1≤L2≤1.25×L1 is more preferably satisfied, and L1=L2 is even more preferably satisfied. For example, when the distance L1 between the first nozzle 21A and the first portion 161 and the distance L2 between the second nozzle 21B and the second portion 162 differ significantly from the above range, a distance from the first pressure chamber 12A to the first nozzle 21A and a distance from the second pressure chamber 12B to the second nozzle 21B become significantly different. As a result, a difference in flow path resistance (which is equivalent to the difference in pressure loss) between the two becomes large, and the ink ejected from the first nozzle 21A and the ink ejected from the second nozzle 21B exhibit significantly different ink ejection characteristics, such as ink weight and flying speed. When the difference between the distance L1 and the distance L2 satisfies 0.50×L1≤L2≤2.00×L1 as described above, it is possible to reduce the difference in the ejection characteristics of the ink ejected from each of the first nozzle 21A and the second nozzle 21B. When the difference between the distance L1 and the distance L2 satisfies 0.80×L1≤L2≤1.25×L1 as described above, it is possible to further reduce the difference in the ejection characteristics of the ink ejected from each of the first nozzle 21A and the second nozzle 21B. When there is no difference between the distance L1 and the distance L2, that is, when L1=L2 is satisfied, the difference in the ejection characteristics of the ink ejected from each of the first nozzle 21A and the second nozzle 21B can be further reduced. As a result, it is possible to suppress the landing position deviation of the ejected ink to the medium, to make the sizes of the dots landed on the medium uniform, and to improve the print quality.

In addition, when the distance L1 in the Y-axis direction between the first nozzle 21A and the first portion 161, the distance L2 in the Y-axis direction between the second nozzle 21B and the second portion 162, and a width W in the Y-axis direction of the first portion 161 are defined, it is preferable that L1≥W and L2≥w be satisfied. When the distance L1 and the distance L2 are relatively short, the interval in the Y-axis direction between the first nozzle 21A and the second nozzle 21B becomes small, and the first nozzle 21A and the second nozzle 21B substantially approach a configuration in which they are arranged side by side in a row on a straight line in the X-axis direction, and it is not possible to suppress the landing position deviation of the ink. Therefore, by making the interval in the Y-axis direction between the first nozzle 21A and the second nozzle 21B relatively large, it is possible to secure a gap between the first nozzle 21A and the second nozzle 21B and to suppress the landing position deviation of the ink.

The nozzle row group 200B also has a similar configuration as the nozzle row group 200A. Here, among the individual flow paths 130, the individual flow path 130 constituting the nozzle row group 200B, that is, the individual flow path 130 having the third nozzle 21C and the fourth nozzle 21D will be described.

As shown in FIGS. 3 and 7, the communication flow path 16 and the pressure chamber 12 which communicate with the third nozzle 21C are referred to as a third communication flow path 16C and a third pressure chamber 12C, and an individual flow path having the third pressure chamber 12C, the third communication flow path 16C, and the third nozzle 21C is referred to as a third individual flow path 133.

As shown in FIGS. 5 and 7, the communication flow path 16 and the pressure chamber 12 which communicate with the fourth nozzle 21D are referred to as a fourth communication flow path 16D and a fourth pressure chamber 12D, and an individual flow path having the fourth pressure chamber 12D, the fourth communication flow path 16D, and the fourth nozzle 21D is referred to as a fourth individual flow path 134. The third individual flow path 133 and the fourth individual flow path 134 communicate with one common manifold 100. The manifold 100 that communicates with the first individual flow path 131 and the second individual flow path 132 and the manifold 100 that communicates with the third individual flow path 133 and the fourth individual flow path 134 are different manifolds and, in the present embodiment, do not communicate with each other. Of course, the two manifolds 100 may communicate with each other. Hereinafter, when the first individual flow path 131, the second individual flow path 132, the third individual flow path 133, and the fourth individual flow path 134 are not distinguished, they are referred to as individual flow paths 130.

The third individual flow path 133 has substantially the same configuration as the first individual flow path 131, and the fourth individual flow path 134 has substantially the same configuration as the second individual flow path 132.

In the present embodiment, the third individual flow path 133 and the fourth individual flow path 134 are alternately arranged along the X-axis direction. That is, the fourth individual flow path 134 is arranged between the two third individual flow paths 133 arranged in the X-axis direction. The third individual flow path 133 is arranged between the two fourth individual flow paths 134 arranged in the X-axis direction.

Specifically, the third individual flow path 133 is arranged at a position shifted in the +Y direction, which is one side in the Y-axis direction, from the first individual flow path 131 and the second individual flow path 132. Here, the third individual flow path 133 being arranged at a position shifted in the +Y direction from the first individual flow path 131 and the second individual flow path 132 means that the third individual flow path 133 is at a position shifted in the +Y direction not to overlap the first individual flow path 131 and the second individual flow path 132 when viewed from the X-axis direction.

The third communication flow path 16C of the third individual flow path 133 has a fifth portion 165 extending in the Z-axis direction. The third nozzle 21C is located further on one side than the fifth portion 165 in the Y-axis direction, that is, further in the +Y direction than is the fifth portion 165 in the present embodiment. The third nozzle 21C being located further in the +Y direction than is the fifth portion 165 means that the third nozzle 21C and the fifth portion 165 do not overlap each other when viewed in the Z-axis direction, and the center of the third nozzle 21C is located further in the +Y direction than is the center of the fifth portion 165. The third communication flow path 16C further includes a seventh portion 167 having one end communicating with the fifth portion 165 and the other end communicating with the third nozzle 21C.

The fifth portion 165 is provided to penetrate the communication plate 15 in the Z-axis direction. The fifth portion 165 is provided linearly along the Z-axis direction with the same opening area. The one end of the fifth portion 165 communicates with an end portion of the third pressure chamber 12C in the −Y direction.

The seventh portion 167 extends in the +Y direction from the fifth portion 165 to the third nozzle 21C. The seventh portion 167 is defined by providing a recessed portion which is opened on a surface of the communication plate 15 facing in the +Z direction and covering the recessed portion with the nozzle plate 20. In the present embodiment, the seventh portion 167 is provided to penetrate the second communication plate 152 in the Z-axis direction. That is, the seventh portion 167 is defined by a recessed portion formed by a surface of the first communication plate 151 facing in the +Z direction and a groove provided in the second communication plate 152, the recessed portion being covered with the nozzle plate 20. That is, the seventh portion 167 has the same depth in the Z-axis direction as the third portion 163 and the fourth portion 164.

Similarly to the third portion 163, the seventh portion 167 has a so-called high aspect ratio and is long in the Y-axis direction and short in the X-axis direction. A direction in which the seventh portion 167 extends is a longitudinal direction based on a portion communicating with the fifth portion 165, and coincides with the +Y direction. Similarly to the third portion 163, the seventh portion 167 may have substantially the same length in the X-axis direction and the Y-axis direction, or may be longer in the X-axis direction and shorter in the Y-axis direction. In this case, the direction in which the seventh portion 167 extends is a direction in which the ink flows. That is, the direction in which the ink flows in the seventh portion 167 coincides with the +Y direction.

The fourth individual flow path 134 is arranged on one side in the Y-axis direction with respect to the first individual flow path 131 and the second individual flow path 132, and in the present embodiment, in the +Y direction. That is, similarly to the third individual flow path 133, the fourth individual flow path 134 is arranged at a position not overlapping the first individual flow path 131 and the second individual flow path 132 when viewed in the X-axis direction.

The fourth communication flow path 16D of the fourth individual flow path 134 has a sixth portion 166 extending in the Z-axis direction. The fourth nozzle 21D is located further on the other side than the sixth portion 166 in the Y-axis direction, that is, further in the −Y direction than is the sixth portion 166 in the present embodiment. The fourth nozzle 21D being located further in the −Y direction than is the sixth portion 166 means that the fourth nozzle 21D and the sixth portion 166 do not overlap each other when viewed in the Z-axis direction, and the center of the fourth nozzle 21D is located further in the −Y direction than is the center of the sixth portion 166. The fourth nozzle 21D is located in the +Y direction with respect to the first nozzle 21A. That is, the fourth nozzle 21D is not arranged at a position overlapping the first nozzle 21A when viewed in the X-axis direction. Therefore, the first nozzle 21A and the fourth nozzle 21D are arranged at positions sufficiently separated in the Y-axis direction. The fourth communication flow path 16D further includes an eighth portion 168 having one end communicating with the sixth portion 166 and the other end communicating with the fourth nozzle 21D.

The sixth portion 166 is provided to penetrate the communication plate 15 in the Z-axis direction. The sixth portion 166 is provided linearly along the Z-axis direction with the same opening area. The one end of the sixth portion 166 communicates with an end portion of the fourth pressure chamber 12D in the −Y direction.

The eighth portion 168 extends from the sixth portion 166 to the fourth nozzle 21D in the −Y direction. The eighth portion 168 is defined by providing a recessed portion which is opened on a surface of the communication plate 15 facing in the +Z direction and covering the recessed portion with the nozzle plate 20. In the present embodiment, the eighth portion 168 is provided to penetrate the second communication plate 152 in the Z-axis direction. That is, the eighth portion 168 is defined by a recessed portion formed by a surface of the first communication plate 151 facing in the +Z direction and a groove provided in the second communication plate 152, the recessed portion being covered with the nozzle plate 20. That is, the eighth portion 168, the seventh portion 167, the third portion 163, and the fourth portion 164 have the same depth in the Z-axis direction.

Similarly to the seventh portion 167, the eighth portion 168 has a so-called high aspect ratio and is long in the Y-axis direction and short in the X-axis direction. A direction in which the eighth portion 168 extends is a longitudinal direction based on a portion communicating with the sixth portion 166, and coincides with the −Y direction. Similarly to the seventh portion 167, the eighth portion 168 may have substantially the same length in the X-axis direction and the Y-axis direction, or may be longer in the X-axis direction and shorter in the Y-axis direction. In this case, the direction in which the eighth portion 168 extends is the direction in which the ink flows. That is, the direction in which the ink flows in the eighth portion 168 coincides with the −Y direction.

In this manner, in each nozzle row 201, the nozzles 21 can be arranged at a density lower than that of the pressure chambers 12 in the X-axis direction. That is, in the nozzle row 201C, the third nozzles 21C can be arranged at a wider interval in the X-axis direction than the pressure chamber 12. Similarly, in the nozzle row 201D, the fourth nozzles 21D can be arranged at a wider interval in the X-axis direction than the pressure chamber 12. Therefore, since a gap is formed between the self-jets generated by ink ejected from each nozzle 21, an airflow between the medium and the liquid ejecting head can pass through the gap due to the relative movement between the medium and the liquid ejecting head H. Since the third nozzle 21C and the fourth nozzle 21D are sufficiently separated from each other in the Y-axis direction, a gap is also formed between the third nozzle 21C and the fourth nozzle 21D, and an airflow between the medium and the liquid ejecting head can pass through the gap due to the relative movement between the medium and the liquid ejecting head H. Therefore, since the airflow in a nozzle arrangement direction is suppressed, it is possible to suppress landing deviation due to the airflow of the flying ink and to cause the ink to land on a desired position of the medium.

By arranging the nozzles 21 constituting the nozzle row group 200B at a relatively wide interval in the X-axis direction, satellite droplets separated from the main droplets are less likely to be largely swirled up by the airflow of the ejected ink, and it is possible to suppress the occurrence of printing stains, called wind ripples, which are caused by irregular adhesion of the satellite droplets due to the airflow. Incidentally, when the nozzles 21 are close to each other and are arranged at a high density, the satellite droplets separated from the main droplets are largely swirled up by the airflow due to the ejected ink droplets and irregularly adhere to the medium, thereby generating the wind ripple.

A relationship between a distance between the third nozzle 21C and the fifth portion 165 in the Y-axis direction and a distance between the fourth nozzle 21D and the sixth portion 166 preferably satisfies the same relationship as the above-described relationship between the distance L1 between the first nozzle 21A and the first portion 161 and the distance L2 between the second nozzle 21B and the second portion 162. As a result, it is possible to reduce the difference in the ejection characteristics of the ink ejected from each of the third nozzle 21C and the fourth nozzle 21D, and it is possible to suppress the landing position deviation of the ejected ink on the medium and to make the sizes of the dots landed on the medium uniform.

It is also preferable that a relationship among the distance between the third nozzle 21C and the fifth portion 165 in the Y-axis direction, the distance between the fourth nozzle 21D and the sixth portion 166 in the Y-axis direction, and a width in the Y-axis direction of the fifth portion 165 satisfies the same relationship as the above-described relationship among the distance L1, the distance L2, and the width W. By satisfying such a relationship, it is possible to secure the gap between the third nozzle 21C and the fourth nozzle 21D, and to suppress the landing position deviation of the ink.

In the present embodiment, the first individual flow path 131 and the fourth individual flow path 134 are arranged at different positions in the X-axis direction. The second individual flow path 132 and the fourth individual flow path 134 are arranged at different positions in the X-axis direction. In the present embodiment, the first individual flow path 131 and the third individual flow path 133 are arranged at the same position in the X-axis direction. The second individual flow path 132 and the fourth individual flow path 134 are arranged at the same position in the X-axis direction.

Accordingly, an interval between the first nozzle 21A and the fourth nozzle 21D in the Y-axis direction is increased to form a gap between the ink ejected from the first nozzle 21A and the ink ejected from the fourth nozzle 21D, and the airflow between the medium and the liquid ejecting head can pass through the gap due to the relative movement between the medium and the liquid ejecting head H. Therefore, it is possible to cause the ink to land on a desired position of the medium by suppressing the occurrence of landing deviation of the ink ejected from each nozzle 21 due to the airflow of the flying ink. Incidentally, when the first individual flow path 131 and the fourth individual flow path 134 are arranged at the same position in the X-axis direction, the interval between the first nozzle 21A and the fourth nozzle 21D in the Y-axis direction becomes small, and the landing position deviation of the ink is likely to occur due to the influence of the airflow of the flying ink.

As long as the first individual flow path 131 and the fourth individual flow path 134 are arranged at different positions in the X-axis direction, the first individual flow path 131 and the third individual flow path 133 may be arranged at different positions in the X-axis direction. That is, the first individual flow path 131 and the third individual flow path 133 may be arranged to be shifted from each other in the X-axis direction by a half pitch of the pitch of the pressure chamber 12 in the X-axis direction. As described above, even when the first individual flow path 131 and the third individual flow path 133 are arranged to be shifted in the X-axis direction, as long as the first individual flow path 131 and the fourth individual flow path 134 are arranged at different positions in the X-axis direction, it is possible to increase the interval between the first nozzle 21A and the fourth nozzle 21D, and to suppress the landing position deviation due to the airflow. Similarly, as long as the second individual flow path 132 and the third individual flow path 133 are arranged at different positions in the X-axis direction, the second individual flow path 132 and the fourth individual flow path 134 may be arranged at different positions in the X-axis direction. That is, the second individual flow path 132 and the fourth individual flow path 134 may be arranged to be shifted from each other in the X-axis direction by a half pitch of the pitch of the pressure chamber 12 in the X-axis direction.

An interval D1 between the second nozzle 21B and the first nozzle 21A in the Y-axis direction, an interval D2 between the first nozzle 21A and the fourth nozzle 21D in the Y-axis direction, and an interval D3 between the fourth nozzle 21D and the third nozzle 21C in the Y-axis direction are all preferably larger than the width W of the first portion 161 in the Y-axis direction. That is, it is preferable to satisfy D1>W, D2>W, and D3>W. Accordingly, the intervals in the Y-axis direction between the second nozzle 21B, the first nozzle 21A, the fourth nozzle 21D, and the third nozzle 21C are increased, thereby suppressing the approach of the configuration in which each nozzle 21 is arranged in a row on a straight line in the X-axis direction, and by forming gaps between each nozzle 21, it is possible to suppress the landing position deviation of the ink. In the present embodiment, the distances D1, D2, and D3 are the center-to-center distances of the nozzles 21, but the present disclosure is not particularly limited thereto, and comparison may be made based on the interval from an opening edge portion of one nozzle 21 to an opening edge portion of another nozzle 21.

The interval D1 and the interval D3 are preferably larger than the interval D2. That is, it is preferable that D1>D2 and D3>D2 be satisfied. Accordingly, the interval D3 between the first nozzle 21A and the fourth nozzle 21D in the Y-axis direction can be made relatively large to secure a gap between the first nozzle 21A and the fourth nozzle 21D, thereby suppressing the landing position deviation of the ink.

In addition, when the distance L1 in the Y-axis direction between the first nozzle 21A and the first portion 161, the distance L2 in the Y-axis direction between the second nozzle 21B and the second portion 162, the width W in the Y-axis direction of the first portion 161, and a distance D between the two first nozzles 21A in the X-axis direction are defined, it is preferable that L1+L2+W≥D be satisfied. With such a relationship, the distance between the nozzles 21 can be widened to suppress the landing position deviation of the ink.

In the present embodiment, the third individual flow path 133 and the fourth individual flow path 134 are provided, but the present disclosure is not particularly limited thereto, and only the first individual flow path 131 and the second individual flow path 132 may be provided without providing the third individual flow path 133 and the fourth individual flow path 134.

In the present embodiment, the X-axis direction is an example of a “first direction”, the Y-axis direction is an example of a “second direction”, the +Y direction is an example of “one side of the second direction”, the −Y direction is an example of “another side of the second direction”, and the Z-axis direction is an example of a “third direction”.

### Second Embodiment

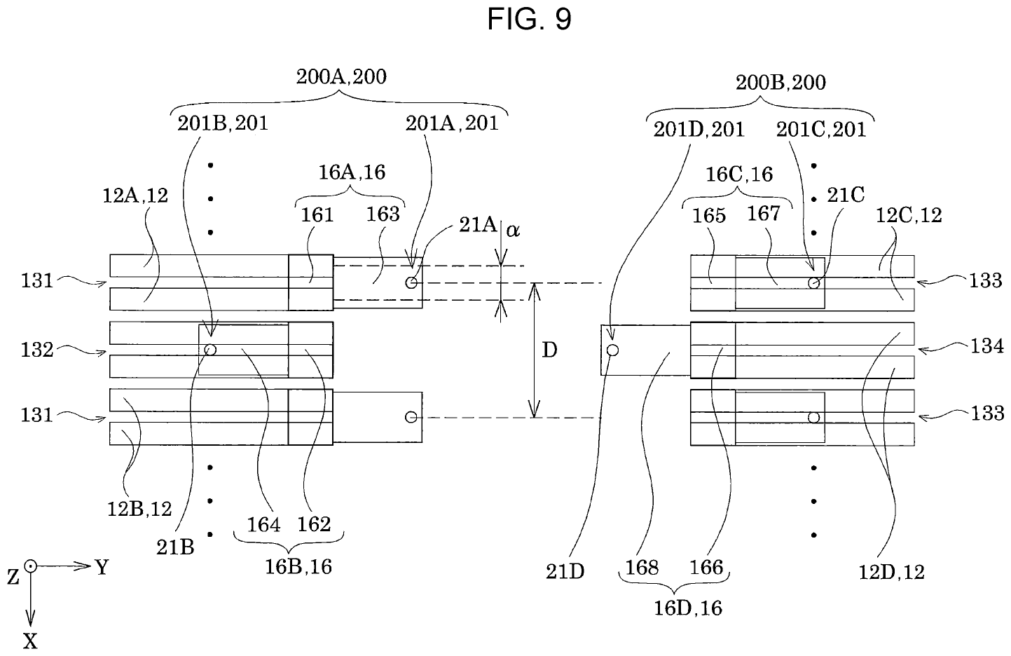

FIG. 9 is a plan view of a liquid ejecting head H showing a positional relationship of individual flow paths according to the second embodiment of the present disclosure, as viewed in the −Z direction. The same reference numerals are used for the same members as those in the above-described embodiment, and repetitive description will be omitted.

As shown in FIG. 9, the liquid ejecting head H of the present embodiment includes the first individual flow path 131, the second individual flow path 132, the third individual flow path 133, and the fourth individual flow path 134.

Although not particularly shown, similarly to the first embodiment described above, the first individual flow path 131 and the second individual flow path 132 communicate with one manifold 100, and the third individual flow path 133 and the fourth individual flow path 134 communicate with one manifold 100. The manifold 100 that communicates with the first individual flow path 131 and the second individual flow path 132 and the manifold 100 that communicates with the third individual flow path 133 and the fourth individual flow path 134 are different manifolds and, in the present embodiment, do not communicate with each other.

Each individual flow path 130 of the present embodiment includes two pressure chambers 12, one communication flow path 16 communicating with the two pressure chambers 12, and one nozzle 21 communicating with the communication flow path 16.

That is, the first individual flow path 131 includes two first pressure chambers 12A adjacent to each other in the X-axis direction, one first communication flow path 16A communicating with the two first pressure chambers 12A, and one first nozzle 21A communicating with the first communication flow path 16A.

Each of the second individual flow paths 132 includes two second pressure chambers 12B adjacent to each other in the X-axis direction, one second communication flow path 16B communicating with the two second pressure chambers 12B, and one second nozzle 21B communicating with the second communication flow path 16B.

The first communication flow path 16A includes the first portion 161 and the third portion 163 as in the first embodiment described above. The second communication flow path 16B includes the second portion 162 and the fourth portion 164 as in the first embodiment described above. The first portion 161, the second portion 162, the third portion 163, and the fourth portion 164 are the same as those in the first embodiment described above, and thus repetitive description will be omitted.

In this manner, since one communication flow path 16 communicates with two pressure chambers 12, it is possible to increase the weight of the ink ejected from the nozzles 21, and it is possible to increase the flying speed. Since the ink ejected from the nozzles 21 is decelerated due to air resistance until the ink lands on the medium, the ink is significantly decelerated when the interval between the liquid ejecting head H and the medium is large. The decelerated ink is easily moved by the flow of air, and landing position deviation easily occurs. As in the present embodiment, by increasing the weight of the ink ejected from the nozzles 21 and increasing the flying speed, it is possible to suppress the landing position deviation due to the airflow even when the speed is reduced. Therefore, even when the interval between the liquid ejecting head H and the medium in the Z-axis direction is increased, the landing position deviation of the ink can be suppressed. It is possible to perform ejection of ink having different weights between the ejection of ink in which only one of the two pressure chambers 12 is driven and the ejection of ink in which both of the two pressure chambers 12 are driven. Therefore, it is possible to perform high-speed printing, high-resolution printing, or the like through the ejection of ink having different weights.

In the nozzle row 201, the distance between the two nozzles 21 in the X-axis direction, for example, the distance D between the two first nozzles 21A of the nozzle row 201A in the X-axis direction can be set to four times the distance between the two pressure chambers 12 in the X-axis direction, that is, a density of ¼×α[dpi] which is one-fourth of the density α[dpi] of the pressure chambers 12. Therefore, a gap can be further provided between the nozzles 21 to suppress the landing position deviation of the ink due to the flow velocity from self-jets.

Similarly to the first individual flow path 131 and the second individual flow path 132, each of the third individual flow path 133 and the fourth individual flow path 134 of the present embodiment has two pressure chambers 12.

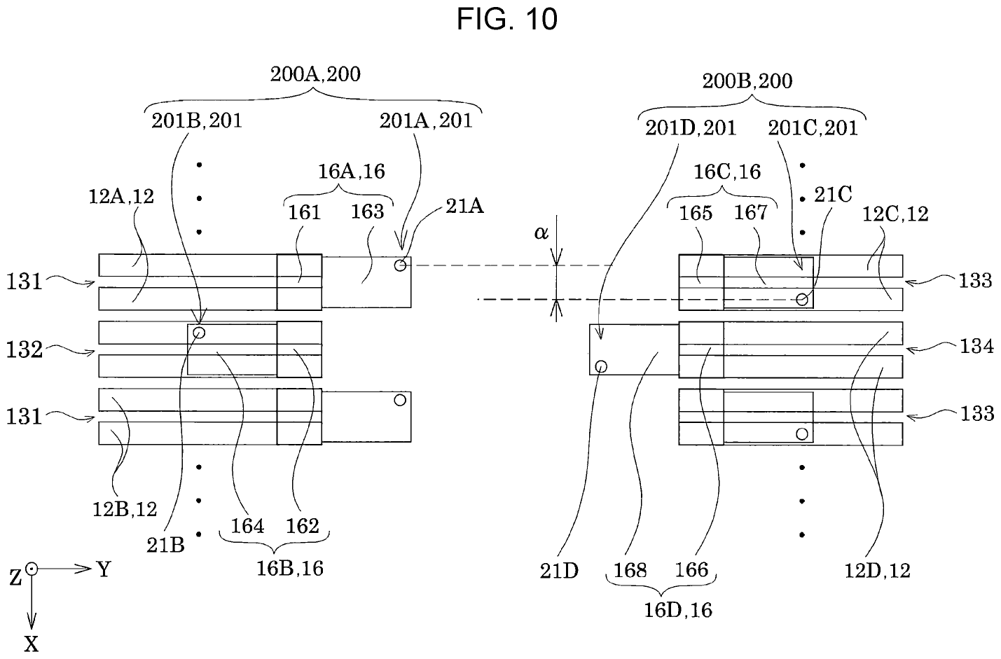

In the present embodiment, the nozzle 21 is arranged at the center of the communication flow path 16 in the Z-axis direction, but is not particularly limited thereto. FIG. 10 shows a modification example of the second embodiment. FIG. 10 is a plan view of the liquid ejecting head H showing a modification example of the individual flow path of the second embodiment, as viewed in the −Z direction.

As shown in FIG. 10, the first nozzle 21A is arranged to be shifted in the −X direction from the center within a width of the first communication flow path 16A in the X-axis direction.

Similarly, the second nozzle 21B is arranged to be shifted in the −X direction from the center within a width of the second communication flow path 16B in the X-axis direction.

In contrast, the third nozzle 21C is arranged to be shifted in the +X direction from the center within a width of the third communication flow path 16C in the X-axis direction. Similarly, the fourth nozzle 21D is arranged to be shifted in the +X direction from the center within a width of the fourth communication flow path 16D in the X-axis direction.

That is, the first nozzle 21A and the third nozzle 21C are arranged at different positions in the X-axis direction, and the second nozzle 21B and the fourth nozzle 21D are arranged at different positions in the X-axis direction.

By arranging each of the nozzles 21 in this way, the first nozzle 21A and the second nozzle 21B can be arranged at the same α[dpi] as the pressure chambers 12 in the X-axis direction. Similarly, the third nozzle 21C and the second nozzle 21B can be arranged at α[dpi] in the X-axis direction, the second nozzle 21B and the fourth nozzle 21D can be arranged at α[dpi] in the X-axis direction, and the fourth nozzle 21D and the first nozzle 21A can be arranged at α[dpi] in the X-axis direction. Therefore, high-resolution printing can be realized.

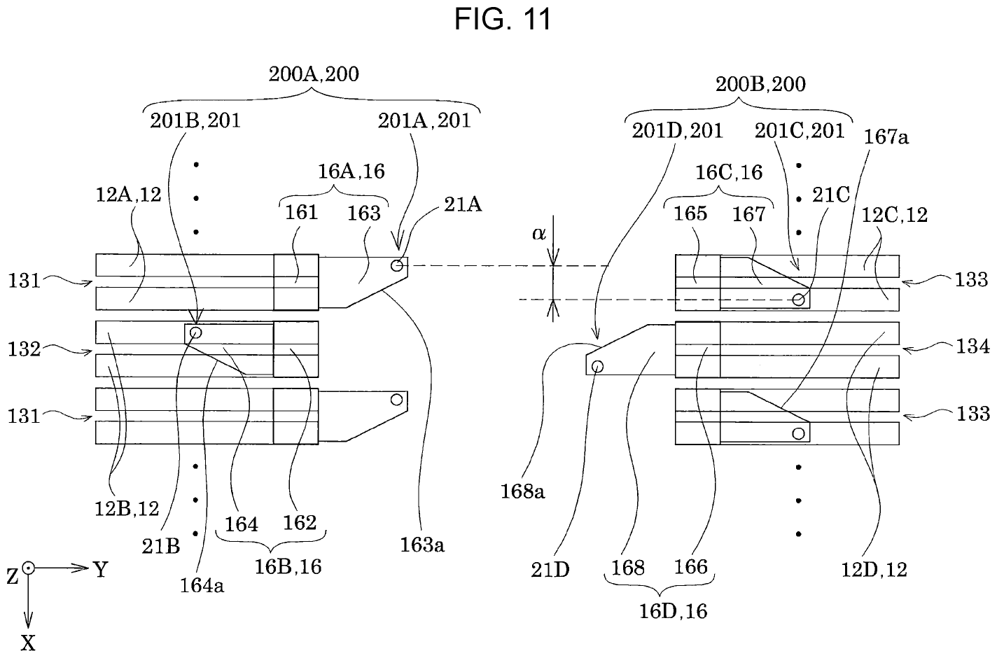

FIG. 11 shows a modification example of FIG. 9. FIG. 11 is a plan view of the liquid ejecting head H showing a modification example of the individual flow path of the second embodiment, as viewed in the −Z direction.

As shown in FIG. 11, the third portion 163 has a first tapered portion 163a whose width in the X-axis direction gradually decreases toward the first nozzle 21A. The first tapered portion 163a of the present embodiment is formed by gradually narrowing a width of the third portion 163 from one side in the X-axis direction. The first tapered portion 163a may be formed by narrowing the width of the third portion 163 from both sides in the X-axis direction. By providing the first tapered portion 163a in the third portion 163 in this way, it is possible to reduce a portion in which the flow of the ink toward the first nozzle 21A stagnates and to suppress the stagnation of the air bubbles in the first individual flow path 131. That is, as shown in FIG. 9, when the first nozzle 21A is arranged to be shifted from the center in the −X direction within the width of the third portion 163 in the X-axis direction, the flow of the ink stagnates at corner portions of the third portion 163 in the +Y direction and the −X direction, and the air bubbles tend to remain at the portions. In particular, since the first communication flow path 16A of the present embodiment communicates with the two first pressure chambers 12A, the first communication flow path 16A is relatively wide in the X-axis direction and tends to stagnate at the corner portions. There is a concern that the air bubbles remained in the flow path grow, the air bubbles absorb the fluctuation in the pressures of the pressure chambers 12, causing the ejection failure of the ink, or the grown air bubbles move to the first nozzle 21A at an unexpected timing, resulting in the ejection failure of the ink. In the present embodiment, by providing the first tapered portion 163a also in the third portion 163, it is possible to reduce a portion in which air bubbles are likely to remain and to suppress the ejection failure of the ink. The fourth portion 164 of the second individual flow path 132, the seventh portion 167 of the third individual flow path 133, and the eighth portion 168 of the fourth individual flow path 134 are also provided with a second tapered portion 164a, a third tapered portion 167a, and a fourth tapered portion 168a similar to the first tapered portion 163a of the third portion 163. By providing the second tapered portion 164a, the third tapered portion 167a, and the fourth tapered portion 168a in this way, it is more difficult for air bubbles to remain in each individual flow path 130, thereby suppressing the ejection failure of the ink.

In the present embodiment, the third individual flow path 133 and the fourth individual flow path 134 are provided, but the present disclosure is not particularly limited thereto, and only the first individual flow path 131 and the second individual flow path 132 may be provided without providing the third individual flow path 133 and the fourth individual flow path 134.

In the present embodiment, the ink is supplied from the manifold 100 (also referred to as a supply common flow path) to the first pressure chamber 12A and the second pressure chamber 12B, but the present disclosure is not particularly limited thereto. For example, a common discharge flow path for discharging the ink in the liquid ejecting head H to the outside may be provided separately from the manifold 100 which is a supply common flow path for supplying the ink from the outside.

The manifold 100 communicates with one of the two first pressure chambers 12A constituting the first individual flow path 131 and one of the two second pressure chambers 12B constituting the second individual flow path 132. The common discharge flow path communicates with the other of the two first pressure chambers 12A constituting the first individual flow path 131 and the other of the two second pressure chambers 12B constituting the second individual flow path 132. Accordingly, the ink supplied from the manifold 100 is supplied to one of the two first pressure chambers 12A, and is supplied to the other of the two first pressure chambers 12A via the first communication flow path 16A. Then, the ink supplied to the other of the first pressure chambers 12A is discharged to the outside of the liquid ejecting head H via the common discharge flow path. Even in such a configuration, as described above, it is possible to suppress the landing position deviation of the ink ejected from the nozzle 21 on the medium.

In the present embodiment, the first individual flow path 131 has one first communication flow path 16A, that is, one first portion 161, but is not particularly limited thereto. For example, the first communication flow path 16A may have two first portions 161 that communicate with the respective first pressure chambers 12A. However, the two first portions 161 only need to communicate in common with one third portion 163. The same applies to the second individual flow path 132, the third individual flow path 133, and the fourth individual flow path 134.

In the present embodiment, a configuration in which two pressure chambers 12 are provided in one individual flow path 130 is adopted, but the present disclosure is not particularly limited thereto, and a configuration in which three or more pressure chambers 12 are provided in one individual flow path 130 may be adopted.

In the present embodiment, the X-axis direction is an example of a “first direction”, the Y-axis direction is an example of a “second direction”, the +Y direction is an example of “one side of the second direction”, the −Y direction is an example of “another side of the second direction”, and the Z-axis direction is an example of a “third direction”.

### Third Embodiment

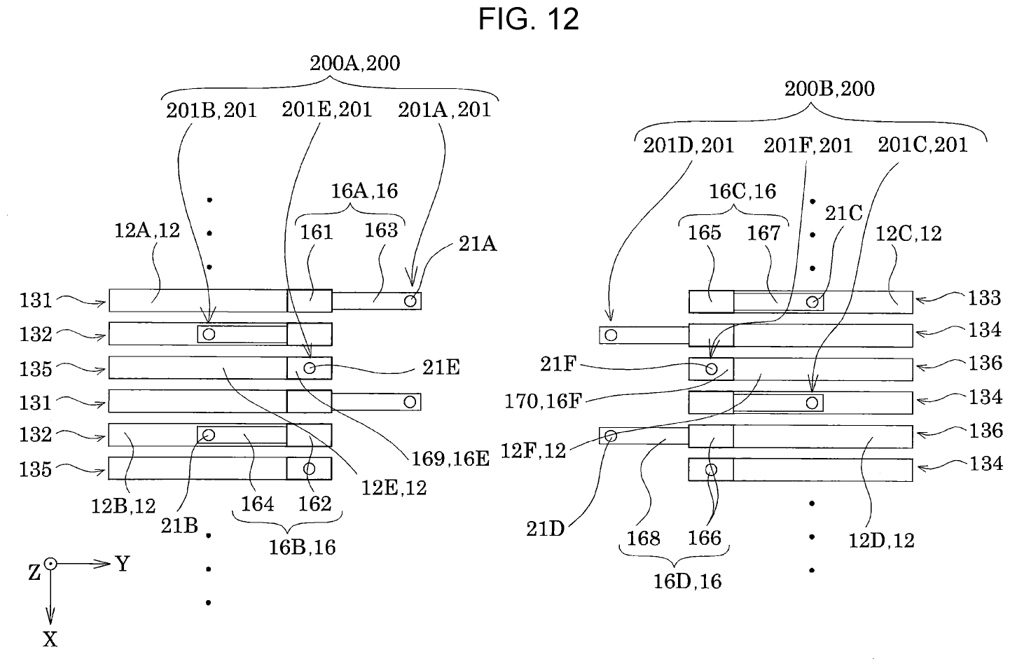

FIG. 12 is a plan view of a liquid ejecting head H showing a positional relationship of individual flow paths according to the third embodiment of the present disclosure, as viewed in the −Z direction. The same reference numerals are used for the same members as those in the above-described embodiment, and repetitive description will be omitted.

As shown in FIG. 12, the liquid ejecting head H of the present embodiment has nozzle row groups 200A and 200B as the nozzle row group 200. The nozzle row group 200A includes three nozzle rows 201 of nozzle rows 201A, 201B, and 201E.

The nozzle row group 200A is constituted by three types of individual flow paths 130. Three types of individual flow paths 130 include a first individual flow path 131 having a first nozzle 21A, a second individual flow path 132 having a second nozzle 21B, and a fifth individual flow path 135 having a fifth nozzle 21E. Since the first individual flow path 131 and the second individual flow path 132 are the same as those of the first embodiment described above, repetitive description will be omitted.

The fifth individual flow path 135 includes a fifth pressure chamber 12E, a fifth communication flow path 16E, and the fifth nozzle 21E.

The fifth communication flow path 16E includes a ninth portion 169 extending in the Z-axis direction. The fifth nozzle 21E is located between the first nozzle 21A and the second nozzle 21B in the Y-axis direction. That is, the fifth nozzle 21E directly communicates with the ninth portion 169.

Such a fifth individual flow path 135 is arranged between the second individual flow path 132 and the first individual flow path 131 in the X-axis direction. That is, the first individual flow path 131, the second individual flow path 132, and the fifth individual flow path 135 are repeatedly arranged in this order in the X-axis direction.

For this reason, the nozzle row group 200A includes the nozzle row 201A in which a plurality of first nozzles 21A are linearly arranged side by side along the X-axis direction, the nozzle row 201B in which a plurality of second nozzles 21B are linearly arranged side by side along the X-axis direction, and the nozzle row 201E in which a plurality of fifth nozzles 21E are linearly arranged side by side along the X-axis direction. The nozzle row 201B, the nozzle row 201E, and the nozzle row 201A are arranged side by side in this order in the +X direction. That is, the second nozzle 21B, the fifth nozzle 21E, and the first nozzle 21A are arranged side by side in this order in the +X direction.

Even in such a configuration, it is possible to widen the interval of the first nozzles 21A in the X-axis direction in the nozzle row 201A. In addition, it is possible to widen the interval of the second nozzles 21B in the X-axis direction in the nozzle row 201B, and it is possible to widen the interval of the fifth nozzles 21E in the X-axis direction in the nozzle row 201E. Therefore, since a gap is formed between the self-jets generated by ink ejected from each nozzle 21, an airflow between the medium and the liquid ejecting head can pass through the gap due to the relative movement between the medium and the liquid ejecting head H. Since the first nozzle 21A, the second nozzle 21B, and the fifth nozzle 21E are sufficiently separated in the Y-axis direction compared to FIG. 8, sufficient gaps are formed between the first nozzle 21A and the second nozzle 21B, between the second nozzle 21B and the fifth nozzle 21E, and between the first nozzle 21A and the fifth nozzle 21E, and the airflow between the medium and the liquid ejecting head can pass through the gaps due to the relative movement between the medium and the liquid ejecting head H. Therefore, since the airflow in a nozzle arrangement direction is suppressed, it is possible to suppress landing deviation due to the airflow of the flying ink and to cause the ink to land on a desired position of the medium.

In the present embodiment, a sixth individual flow path 136 similar to the fifth individual flow path 135 is also provided on the nozzle row group 200B side, that is, the side on which the third individual flow path 133 and the fourth individual flow path 134 are arranged side by side in the X-axis direction. The sixth individual flow path 136 includes a sixth pressure chamber 12F, a sixth communication flow path 16F, and a sixth nozzle 21F. The sixth communication flow path 16F includes a tenth portion 170 extending in the Z-axis direction, and an end portion of the tenth portion 170 in the +Z direction directly communicates with the sixth nozzle 21F. The third individual flow path 133, the fourth individual flow path 134, and the sixth individual flow path 136 are repeatedly arranged in this order in the +Y direction. That is, the nozzle row group 200B includes a nozzle row 201D in which a plurality of fourth nozzles 21D are linearly arranged side by side along the X-axis direction, a nozzle row 201F in which a plurality of sixth nozzles 21F are linearly arranged side by side along the X-axis direction, and a nozzle row 201C in which a plurality of third nozzles 21C are linearly arranged side by side along the X-axis direction. The nozzle row 201D, the nozzle row 201F, and the nozzle row 201C are arranged side by side in this order in the +Y direction.

Even in such a nozzle row group 200B, similar to the nozzle row group 200A, gaps are formed between the self-jets generated by the ink ejected from each nozzle 21, and thus the airflow between the medium and the liquid ejecting head can pass through the gaps due to the relative movement between the medium and the liquid ejecting head H. Therefore, since the airflow in a nozzle arrangement direction is suppressed, it is possible to suppress landing deviation due to the airflow of the flying ink and to cause the ink to land on a desired position of the medium.

In the present embodiment, the first individual flow path 131, the second individual flow path 132, and the fifth individual flow path 135 are repeatedly arranged side by side in this order in the +X direction, but the present disclosure is not particularly limited thereto, and the first individual flow path 131, the fifth individual flow path 135, and the second individual flow path 132 may be repeatedly arranged side by side in this order in the +X direction. The same applies to the third individual flow path 133, the fourth individual flow path 134, and the sixth individual flow path 136.

In addition, in the present embodiment, the third individual flow path 133, the fourth individual flow path 134, and the sixth individual flow path 136 which constitute the nozzle row group 200B are provided, but the present disclosure is not particularly limited thereto, and these may not be provided.

In the present embodiment, the X-axis direction is an example of a “first direction”, the Y-axis direction is an example of a “second direction”, the +Y direction is an example of “one side of the second direction”, the −Y direction is an example of “another side of the second direction”, and the Z-axis direction is an example of a “third direction”.

### Other Embodiments

Although the embodiments of the present disclosure have been described above, the basic configuration of the present disclosure is not limited to those described above.

For example, in each of the embodiments described above, the first portion 161 and the second portion 162 extending along the Z-axis direction and linearly provided with the same opening area along the Z-axis direction are exemplified, but the present disclosure is not particularly limited thereto. For example, the first portion 161 and the second portion 162 may be provided along a direction inclined at an angle less than 90 degrees with respect to the Z-axis direction. That is, the direction in which the first portion 161 and the second portion 162 extend includes a component (vector) in a direction along the Z-axis direction. The first portion 161 and the second portion 162 are not limited to being provided with the same opening area in the extending direction, and may have a shape in which the opening area changes in a stepwise manner in the middle, for example, a shape in which the opening area gradually decreases toward the downstream. The same applies to the fifth portion 165 and the sixth portion 166.

For example, in each of the embodiments described above, the third portion 163 and the fourth portion 164 extend along the Y-axis direction, but the present disclosure is not particularly limited thereto, and the third portion 163 and the fourth portion 164 may extend in a direction inclined with respect to both the X-axis direction and the Y-axis direction when viewed in the Z-axis direction. That is, the direction in which the third portion 163 and the fourth portion 164 extend includes a component (vector) in a direction along the Y-axis direction. The same applies to the seventh portion 167 and the eighth portion 168.

In each of the embodiments described above, the thin film type piezoelectric actuator 300 has been described as a drive element which causes the pressure change in the pressure chamber 12, but the present disclosure is not particularly limited thereto, and the drive element can be, for example, a thick film type piezoelectric actuator which is formed by a method of attaching a green sheet or the like, a longitudinal vibration type piezoelectric actuator which alternately laminates a piezoelectric material and an electrode forming material and expands and contracts in the axial direction, or the like. In addition, the drive element can be, for example, one in which a heating element is arranged in the pressure chamber 12 to eject liquid droplets from the nozzle 21 through bubbles generated due to the heat of the heating element, or a so-called electrostatic actuator that generates static electricity between a diaphragm and an electrode, deforms the diaphragm by the static electricity, and ejects the liquid droplets from the nozzle 21.

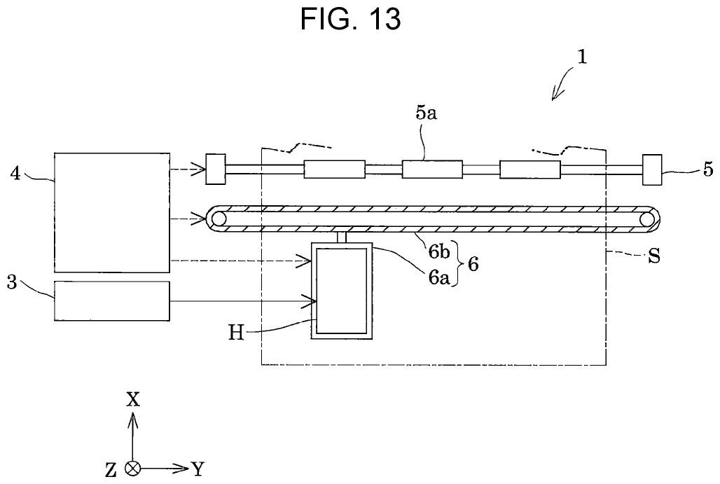

The liquid ejecting head H described above is mounted on a liquid ejecting apparatus 1. FIG. 13 is a diagram showing a schematic configuration of the liquid ejecting apparatus 1 of the present disclosure.

As shown in FIG. 13, the liquid ejecting apparatus 1 is a so-called serial type printer which includes the liquid ejecting head H and performs printing by ejecting liquid in the +Z direction from the liquid ejecting head H toward a medium S while transporting the medium S in the X-axis direction and reciprocating the liquid ejecting head H in the Y-axis direction. An example of the medium S to be used may include any material such as recording paper or a resin film in addition to cloth. The direction in which the liquid ejecting head H reciprocates is not limited to the Y-axis direction, and may be a direction inclined with respect to both the X-axis direction and the Y-axis direction. In the present embodiment, the +Z direction is an example of an “ejection direction”.

Such a liquid ejecting apparatus 1 includes the liquid ejecting head H, a liquid storage portion 3, a control device 4, a transport mechanism 5 that feeds the medium S, and a moving mechanism 6.

The liquid ejecting head H ejects liquid supplied from the liquid storage portion 3 as liquid droplets in the +Z direction.

The liquid storage portion 3 individually stores a plurality of types of liquids having different colors or components, which are ejected from the liquid ejecting head H. Examples of the liquid storage portion 3 include a cartridge that is detachably attached to the liquid ejecting apparatus 1, a bag-shaped ink pack formed of a flexible film, and an ink tank that can be replenished with ink. FIG. 13 shows one liquid storage portion 3. The liquid storage portion 3 may be a liquid storage portion 3 including separate chambers for individually storing the plurality of types of liquids, and may be a plurality of liquid storage portions 3 provided individually according to the plurality of types of liquids. The liquid storage portion 3 may be divided into a main tank and a sub tank. The sub tank may be coupled to the liquid ejecting head H, and the liquid consumed by ejecting the liquid droplets from the liquid ejecting head H may be replenished from the main tank to the sub tank.

The control device 4 integrally controls each element of the liquid ejecting apparatus 1, that is, the liquid ejecting head H, the transport mechanism 5, the moving mechanism 6, and the like.

The transport mechanism 5 transports the medium S in the X-axis direction and includes a transport roller 5a. The transport mechanism 5 transports the medium S in the X-axis direction as the transport roller 5a rotates. The transport roller 5a is rotated by the drive of a transport motor (not shown). The control device 4 controls the transport of the medium S by controlling the drive of a medium transport motor. The transport mechanism 5 that transports the medium S is not limited to a transport mechanism including the transport roller 5a, and may be, for example, a transport mechanism that transports the medium S using a belt or a drum.

The moving mechanism 6 is a mechanism for reciprocating the liquid ejecting head H in the Y-axis direction, and includes a holding body 6a and a transport belt 6b. The holding body 6a is a so-called carriage which holds the liquid ejecting head H, and is fixed to the transport belt 6b. The transport belt 6b is an endless belt stretched along the Y-axis direction. The transport belt 6b is rotated by the drive of a transport motor (not shown). The control device 4 rotates the transport belt 6b by controlling the drive of the transport motor, and causes the liquid ejecting head H to reciprocate in the Y-axis direction together with the holding body 6a. The holding body 6a may have a configuration in which the liquid storage portion 3 is mounted together with the liquid ejecting head H.

The liquid ejecting head H performs an ejecting operation of ejecting the liquid supplied from the liquid storage portion 3 as liquid droplets from each of the plurality of nozzles 21 in the +Z direction under the control of the control device 4. The ejecting operation by the liquid ejecting head H is performed in parallel with the transport of the medium S by the transport mechanism 5 and the reciprocating movement of the liquid ejecting head H by the moving mechanism 6, and thus so-called printing in which liquid is applied to the medium S is performed.

In such a liquid ejecting apparatus 1, an interval in the Z-axis direction between a nozzle surface 20a (see FIG. 3) of the liquid ejecting head H and a surface of the medium S, that is, a so-called paper gap, is preferably 3 mm or more, and more preferably 7 mm or more. In this manner, by setting the paper gap to 3 mm or more, and more preferably 7 mm or more, it is possible to suppress the failure of the liquid ejecting head H due to the collision of the medium S with the liquid ejecting head H. Even when the paper gap is set to 3 mm or more, and more preferably 7 mm or more, it is possible to suppress the landing position deviation of the ink on the medium S and the generation of the wind ripple by using the liquid ejecting head H described above, and to realize the printing with high accuracy.

In the example shown in FIG. 13, the liquid ejecting apparatus 1 in which the liquid ejecting head H is mounted on the holding body 6a and moves in a main scanning direction is exemplified, but the present disclosure is not particularly limited to this. For example, the present disclosure can also be applied to a so-called line-type printer in which the liquid ejecting head H is fixed and printing is performed only by moving the medium S in a sub scanning direction.

The present disclosure is widely intended for liquid ejecting heads and liquid ejecting apparatuses in general, and can be applied to liquid ejecting heads and liquid ejecting apparatuses which eject liquid other than ink. Examples of other liquid ejecting heads include various recording heads used in image recording apparatuses such as printers, color material ejecting heads used in the manufacture of color filters for liquid crystal displays and the like, electrode material ejecting heads used in the formation of electrodes for organic EL displays, field emission displays (FEDs) and the like, and bio-organic substance ejecting heads used in the manufacture of biochips. The present disclosure can also be applied to liquid ejecting apparatuses including such liquid ejecting heads.

What is claimed is:

1. A liquid ejecting head comprising:
a first individual flow path; and
a second individual flow path arranged side by side with the first individual flow path in a first direction,
wherein
the first individual flow path includes
a first pressure chamber extending along a second direction intersecting the first direction and configured to apply pressure to liquid,
a first communication flow path that communicates with the first pressure chamber and includes a first portion extending in a third direction intersecting the first direction and the second direction, and
a first nozzle that communicates with the first communication flow path and ejects liquid,
the second individual flow path includes
a second pressure chamber extending along the second direction and configured to apply pressure to liquid,
a second communication flow path that communicates with the second pressure chamber and includes a second portion extending in the third direction, and
a second nozzle that communicates with the second communication flow path and ejects liquid, and
when viewed from the third direction,
the first nozzle is located further on one side than the first portion in the second direction, and
the second nozzle is located further on an other side than the second portion in the second direction.

2. The liquid ejecting head according to claim 1, wherein
when a distance between the first nozzle and the first portion in the second direction is L1, and a distance between the second nozzle and the second portion in the second direction is L2, 0.50×L1≤L2≤2.00×L1.

3. The liquid ejecting head according to claim 2, wherein
$$0.8 \leq L 1 \leq L 2 \leq 1.25 \times L 1.$$

4. The liquid ejecting head according to claim 1, wherein
when a distance between the first nozzle and the first portion in the second direction is L1, a distance between the second nozzle and the second portion in the second direction is L2, and a width of the first portion in the second direction is W, L1≥W and L2≥W.

5. The liquid ejecting head according to claim 1, wherein
the first communication flow path further includes a third portion extending from the first portion to the first nozzle toward the one side in the second direction, and
the second communication flow path further includes a fourth portion extending from the second portion to the second nozzle toward the other side in the second direction.

6. The liquid ejecting head according to claim 1, further comprising:
a third individual flow path located at a position shifted to the one side in the second direction from the first individual flow path and the second individual flow path; and
a fourth individual flow path arranged side by side with the third individual flow path in the first direction,
wherein
the third individual flow path includes
a third pressure chamber extending along the second direction and configured to apply pressure to liquid,
a third communication flow path that communicates with the third pressure chamber and includes a fifth portion extending in the third direction, and
a third nozzle that communicates with the third communication flow path and ejects liquid,
the fourth individual flow path includes
a fourth pressure chamber extending along the second direction and configured to apply pressure to liquid,
a fourth communication flow path that communicates with the fourth pressure chamber and includes a sixth portion extending in the third direction, and
a fourth nozzle that communicates with the fourth communication flow path and ejects liquid,
the third nozzle is located further on the one side than the fifth portion in the second direction, and
the fourth nozzle is located further on the other side than the sixth portion in the second direction.

7. The liquid ejecting head according to claim 6, wherein
the second nozzle, the first nozzle, the fourth nozzle, and the third nozzle are arranged in order of the second nozzle, the first nozzle, the fourth nozzle, and the third nozzle from the other side toward the one side in the second direction.

8. The liquid ejecting head according to claim 7, wherein
an interval between the second nozzle and the first nozzle in the second direction, an interval between the first nozzle and the fourth nozzle in the second direction, and an interval between the fourth nozzle and the third nozzle in the second direction are all larger than a width of the first portion in the second direction.

9. The liquid ejecting head according to claim 7, wherein
the first individual flow path and the fourth individual flow path are located at different positions in the first direction, and
the second individual flow path and the third individual flow path are located at different positions in the first direction.

10. The liquid ejecting head according to claim 8, wherein
the first individual flow path and the third individual flow path are located at a same position in the first direction, and
the second individual flow path and the fourth individual flow path are located at a same position in the first direction.

11. The liquid ejecting head according to claim 1, wherein
the first individual flow path and the second individual flow path are alternately arranged in the first direction.

12. The liquid ejecting head according to claim 11, wherein
when a distance between the first nozzle and the first portion in the second direction is L1, a distance between the second nozzle and the second portion in the second direction is L2, a width of the first portion in the second direction is W, and a distance between two first nozzles in the first direction is D, L1+L2+W≥D.

13. The liquid ejecting head according to claim 1, further comprising
a fifth individual flow path arranged side by side with the first individual flow path and the second individual flow path in the first direction, wherein
the fifth individual flow path includes
a fifth pressure chamber extending along the second direction and configured to apply pressure to liquid,
a fifth communication flow path that communicates with the fifth pressure chamber and includes a ninth portion extending in the first direction and the third direction, and
a fifth nozzle that communicates with the fifth communication flow path and ejects liquid, and
the fifth nozzle is located between the first nozzle and the second nozzle in the second direction.

14. The liquid ejecting head according to claim 1, wherein
the first individual flow path includes two first pressure chambers adjacent to each other in the first direction and one first nozzle, and
the second individual flow path includes two second pressure chambers adjacent to each other in the first direction and one the second nozzle.

15. The liquid ejecting head according to claim 14, further comprising:
a common supply flow path that communicates in common with the two first pressure chambers and the two second pressure chambers and supplies liquid to each of the two first pressure chambers and the two second pressure chambers.

16. The liquid ejecting head according to claim 14, further comprising:
a common supply flow path that communicates in common with one of the two first pressure chambers and one of the two second pressure chambers and supplies liquid to each of the one of the two first pressure chambers and the one of the two second pressure chambers; and
a common discharge flow path that communicates in common with an other of the two first pressure chambers and an other of the two second pressure chambers and discharges liquid from each of the other of the two first pressure chambers and the other of the two second pressure chambers.

17. The liquid ejecting head according to claim 14, further comprising:
a third individual flow path located at a position shifted to the one side in the second direction from the first individual flow path and the second individual flow path; and
a fourth individual flow path arranged side by side with the third individual flow path in the first direction, wherein
the third individual flow path includes
two third pressure chambers that extend along the second direction and are adjacent to each other in the first direction,
a third communication flow path that communicates with the third pressure chambers and includes a fifth portion extending in the third direction, and
a third nozzle that communicates with the third communication flow path and ejects liquid,
the fourth individual flow path includes
two fourth pressure chambers that extend along the second direction and are adjacent to each other in the first direction,
a fourth communication flow path that communicates with the fourth pressure chambers and includes a sixth portion extending in the third direction, and
a fourth nozzle that communicates with the fourth communication flow path and ejects liquid,
the third nozzle is located further on the one side than the fifth portion in the second direction,
the fourth nozzle is located further on the other side than the sixth portion in the second direction,
the first nozzle is arranged further on one side than the third nozzle in the first direction, and
the second nozzle is arranged further on the one side than the fourth nozzle in the first direction.

18. The liquid ejecting head according to claim 14, wherein
the first communication flow path further includes a third portion extending from the first portion to the first nozzle toward the one side in the second direction, and the third portion includes a first tapered portion in which a width in the first direction gradually decreases toward the first nozzle, and
the second communication flow path further includes a fourth portion extending from the second portion to the second nozzle toward the other side in the second direction, and the fourth portion includes a second tapered portion in which a width in the first direction gradually decreases toward the second nozzle.

19. A liquid ejecting apparatus comprising:
the liquid ejecting head according to claim 1; and
a control portion configured to control an ejecting operation from the liquid ejecting head.

20. The liquid ejecting apparatus according to claim 19, wherein
an interval in the first direction between a nozzle surface on which the first nozzle of the liquid ejecting head opens and a medium on which liquid lands is 3 mm or more.
